(19) United States
(12) Patent Application Publication
(10) Pub. No.: US 2010/0203237 A1
(43) Pub. Date: Aug. 12, 2010

(54) CORROSION PROTECTIVE AND ELECTRICAL CONDUCTIVITY COMPOSITION FREE OF INORGANIC SOLID PARTICLES AND PROCESS FOR THE SURFACE TREATMENT OF METALLIC SHEET

(75) Inventors: Luis Conde Moragues, Rubi (Barcelona) (ES); Ghosh Swapan Kumar, Zelzate (BE)

Correspondence Address: BANNER & WITCOFF, LTD., 1100 13th STREET, N.W., SUITE 1200, WASHINGTON, DC, 20005-4051, US

(73) Assignee: Procoat Tecnologias, S.L.

(21) Appl. No.: 12/601,309

(22) PCT Filed: May 24, 2007
(86) PCT No.: PCT/EP07/04616

§ 371 Date: Apr. 27, 2010

(51) Int. Cl. B05D 5/12; H01B 1/12

(52) U.S. Cl. 427/126.3; 252/512

(57) ABSTRACT

Corrosion and electrical conductive protective composition and process for the surface treatment of metallic sheet with a water based composition containing an organic polymer, and inorganic compounds, the composition does too contain minor amounts of Hydrogen Peroxide or other peroxides, the essential feature of this process is that the coated surface has good corrosion resistance and good electrical conductivity of the coated surface, even that the liquid composition used does not contain conducting inorganic solid particles.

### OBJECT OF THE INVENTION

This invention concerns a process for coating metallic surfaces with a water based composition that besides good corrosion performance and other desirable properties, allowed by compositions of prior art containing polymers and inorganic compounds, does too allow good electrical conductivity of the treated metal surface. This desirable electrical conductivity is obtained by introducing some specific additives that are acting in a synergic way, as water solutions or water emulsions, to the water based organic-inorganic compositions already known.

The composition for this process for coating metallic surfaces is a water based composition containing an organic film forming polymer mix, and inorganic compounds. Having those as anions: glycolates, lactates, oxalates, phosphates, chlorides, sulphates and tartrates of the following cations, aluminium, lithium, potassium, sodium, titanium, trivalent chrome, vanadium, and zinc. And as well eventually hexa-fluorocomplex salts, of, boron, titanium, zirconium and silicium. And specifically some very unusual additives to give electrical conductivity to the treated metal surface. But the essential feature of this process is that the coated surface gets both good corrosion resistance and good electrical conductivity of the coated surface. Even that the liquid composition used does not contain additional conducting inorganic solid particles as suggested in prior art.

The composition used in this process contains, instead of conducting solid inorganic particles, as dissolved additives a very unusual high content of water soluble inorganic metal phosphates and also a very high and unusual content of water soluble organic compounds such as ethoxylated alkyl phosphates, ethoxylated alkyl sulphates or polyethers on basis of ethylene, and or propylene, glycols. Preferably both, inorganic and organic, water soluble additives because they act in a synergic way. The invention concerns the corresponding water based composition, and the uses of the metallic substrates coated by the process according to the invention.

### BACKGROUND OF THE INVENTION

Many processes for metal surface treatment, most especially of metal sheet, have been based on the use of hexavalent Chromium (Chromium VI compounds) since very old times to increase the metal corrosion resistance. Such effect is know as metal surface passivation. More recently the use of hexavalent Chromium associated with polymers and other auxiliaries has increased further the corrosion protection as well has introduced other interesting properties to the metal surfaces, like dry lubricity, and direct paint adhesion without any further pre-treatment. An example of such products, also water based, are described in the U.S. Pat. No. 4,006,041.

Market use also showed that such polymer containing thin films, so applied on metal sheets, were not showing permanent fingerprints like often normal handling does leave on metal surfaces. This feature is found to be most desired for aesthetic reasons in the market.

Concerns on the toxicity and ecological risks associated to hexavalent Chrome and possible legal limitations to his use, raised interest in polymer containing water based processes and compositions free of hexavalent Chrome, but with alternative inorganic metal surface passivation systems. Also the other multifunctional surface features, protection to corrosion and fingerprints, paintability and lubricity were sought in such process. For example EP 0 694 593 describes a process and compositions containing Polymers, Hydrogen Peroxide, Acids and several inorganic passivation compounds, but free of Hexavalent Chromium. The eventual use of electrically conductive solid pigments is also described.

However normally the use of electrically conductive pigments does make the coated surface dull, and with some pigments the surface gets also colour.

A later patent application WO 02/24975 A1, very similar to the former teaches also a composition free of Hexavalent chrome containing polymers, passivation chemicals containing essentially the same elements, phosphoric acid or and a component (G) made by reaction of metallic oxides, hydroxides or carbonates with part of the component A present. This component A is described as fluorometallate anions. This patent application bears a important similarity to EP 0 694 593 and the same to the present process on basis that polymers, several metals, phosphoric acid, fluorometallic acid anions and peroxides are also present.

However none of those patents describes the set of additives proposed in this patent. Neither do they touch the problems related with the application of such polymer containing surface treatments for electronic zinc coated sheet applications. Partly because WO 02/24975 A1 is directed just to improve the adhesion to paints, that as very thick organic coatings normally cannot be conducting. And it chooses treatment dry films of less than 500 milligrams by square meter, just below the lower limit set in the patent EP 0 694 593.

The compositions following the patent EP 0 694 593 however do hardly allow a compromise of good corrosion resistance coupled with simultaneous acceptable electrical conductivity. So a substantial research effort has been followed to find a way to get such a compromise of properties to the treated surfaces according this procedure. The additives and their synergic effects found are the consequence of this effort.

Oil free metal sheet surfaces of sufficient corrosion protection, that can be painted easily at least in one of his sides, that are also provided with enough lubricity for profiling and mild pressing jobs and having too a pleasant surface that will not acquire fingerprints along normal handling are also sought by the electric and electronic industry. But currently the application of metal sheet in electric and electronic equipment additionally requires that also the surface treatments leave the surface with enough electrical conductivity. But by far most organic polymers are intrinsically non conductive. Electrical conductivity is important if electrical grounding of equipment is needed. Also it is important if very small spontaneous static load sparks are avoided because today's electronic circuitry uses very small currents. Conductivity is also important when such sensitive digital circuits have to be protected from the Electro-Magnetic waves present in the ambient. This last effect is normally done by enclosing fully the sensitive electronic equipment, a computer for example, in a closed electrically conducting metal box, like in a Faraday cage, that does block the inside equipment from the outer electromagnetic fields. And all the elements of such cage must be conducting (they are metallic) and also must be then in electrical contact, requiring then that their treated metallic surface treatment leaves the surface also conductive.

As most organic polymers are intrinsically nonconductive, when no conductive pigments or any kind of conductive particles or other preparation are taken, a very narrow compromise in the dry surface film thickness must be found. When the organic film produced by the treatment process is thinner than 0.7 g/m2, and is applied on metal surfaces of enough surface roughness, sufficient surface microscopic metal peaks are left not covered by the polymer and enough conductivity is still measured. But then such porosity makes the corrosion performance lower, or too low. When the treatment film is thicker than 1 g/m2 enough corrosion performance may be assured. But then there is not sufficient electric conductivity. This equilibrium of properties is then hanging on a narrow “window” of organic film thicknesses. And that accurate monitoring of the thickness is barely possible in the existing industrial plants.

As said before, electrical conductivity can be rendered to the polymer films if they also contain, as well as the polymer and the passivation chemicals, electrically conductive solid pigments, or solid fillers. Let us then, in general, describe those as conductive solid particles. Such principle has been widely used since long time in plastic pieces in bulk, on special conductive paints, and also in surface treatments. Conductive particles can be made from finely ground metals, from graphite or similar conductive carbon particles, and from some conductive or semi-conductive salts and oxides.

Also conducting, quite exotic, organic polymer particles, like poly-acetylene, poly-aniline, poly-pyrrol are also known in the literature and have limited industrial applications, but become by far too expensive for such extended area surfaces. Examples of such thin organic film treatments that, as well as polymers, are containing conductive inorganic solid particles and his applications can be seen in US 2004/0054044.

When using solid inorganic conducting particles in the liquid surface treatment composition, a surface treatment, or a coating, can render conductive even if it is thicker than 1.3 g/m2. Such surface can also have very low porosity and achieve good corrosion resistance. Because. the surface gets colour and is dulled by the conducting particles, only sometimes this may not be a relevant drawback. As for example, is not a problem in US 2004/0054044, when all the surface will be covered by paint afterwards.

Some limitations of such exotic conducting organic polymers can be reduced in a big extent and their use is compatible with the additives proposed in this patent application only if they were not used as pigments, or solid particles, but as water emulsions of such conductive organic polymers. But pure conducting organic polymer water based emulsions of reasonable concentration to get a sensible technical effect, of more than 3% solids, are hardly stable.

It is known that by appropriate polymerization techniques it is feasible to enhance substantially the conductivity of films built from conventional polymer emulsions. This can be done by directly polymerizing in situ, on the surface of the micelles on such non conducting organic polymer emulsions, extremely thin shells of the exotic electrically conducting polymers like poly-aniline, poly-pyrrol or poly-thiophene to give some examples. As the amount of such exotic polymer in the composition is then very small, the film does not lose his transparency and brightness, also the cost of the treatment does not change drastically and also there is no need of milling or dispersing solid materials in the final composition. Again synergic effects can be achieved by using this kind of shell-core organic polymers having an enhanced conductivity in combination with the other additives proposed in this application.

Such organic polymer modification can also be used in combination in any proportion with any of the other additives proposed.

### DESCRIPTION OF THE INVENTION

The process and the treatment liquid compositions object of this invention provide sufficient electrical conductivity to the polymer film treated surface with dry film thicknesses high enough to ensure enough corrosion protection but using compositions free of conductive inorganic solid particles.

Problems and costs related with grinding the inorganic solids to a very fine particle size, avoiding the growth of particle agglomerates, and controlling the settling of such inorganic particles in the application equipment can then be avoided.

Furthermore the surface coated with this composition keeps the original pleasant metal surface metallic colour and brightness. Often, as in computer boxes, the treated metal sheet will be only painted on top of the conducting treatment in one of the sides of the sheet, the one left to the outside of the equipment. Normally they are not painted in the inner surfaces of a box because most paints are not electrically conductive, appearance is less demanding and paints are costly.

This advantage is achieved by a process, as described in this patent, for treating a metallic surface, in particular of steel coated with aluminium, magnesium, tin, zinc or his alloys with a Chrome six free composition, either as a pre-treatment prior an additional coating or as a complete treatment alone. The metal part treated being often in sheet form or manufactured from such treated sheet.

Corrosion protective and electrical conductivity composition free of inorganic solid particles comprises at least:

a/ A liquid, water based, solution or emulsion of an organic polymer,

b/ An acidic water based inorganic solution containing at least 3% of the solids contained in the polymer liquid solution or emulsion as dissolved zinc as a cation.

c/ Such water solution containing at least 10% of the solids contained in such polymer liquid solution or emulsion as dissolved phosphoric acid or acidic phosphor based salts.

d/ Other anions, like acetyl-acetonates, glycolates, lactates, oxalates, tartrates and hexa-fluoro complex acids of titanium, zirconium, silicium and boron being eventually present in minor amounts.

Other cations being present like aluminium, lithium, sodium, manganese, molybdenum, potassium, titanium, trivalent chrome, vanadium, are added as oxides, hydroxides or salts. Finally adjusting with the anion contents that all the zinc and the other cations present are fully dissolved in the solution. The acidic inorganic solution, being then fully transparent, ensures that no particles are present.

e/ Some inorganic or organic peroxides in solution.

f/ Optionally some water soluble organic surface active agents at more than 2% concentration calculated on the treatment solid content; like etoxylated alkyl sulphate or ethoxylated alkyl phosphate neutralized with ammonia, lithium, sodium or potassium, or a polyoxyethylene copolymer including also a mixture or such kind of compound with the former ones.

g/ Eventually some liquid silane or silane mix as adhesion promoters, cross-linkers or hydrophobic agents can also be used.

h/ Optionally some emulsion of an electrically conductive organic polymer like poly-aniline, polypirrol and poly-thiophene.

By modifying at least a part of some of the organic polymer emulsions described before, it is possible to enhance their electrical conductivity of his dry films by polymerizing around the core of his emulsified micelles a thin shell of those conductive organic polymers.

The solution or emulsion, being free of inorganic solid particles, is applied to the clean metallic surface as a wet film that is afterwards dried or cured ranging at temperature between 40 and 240° C. by hot air streams, or by inductive heating of the metal sheet, or with radiations like IR, UV or Electron-beams. The temperature is measured in the surface of the metal with a contact thermocouple, diluting the compositions with extra water to adjust the final dry film thickness.

The metal surface being of Aluminium, Magnesium, Tin and Zinc and their alloys, most often those alloys are coatings on a steel sheet.

Such drying leaving then on the metal surface an optically transparent dry film from 0.4 to 5 g/m2. Preferably from 0.7 to 1.3 g/m2.

After drying, despite the high content of inorganic material in the composition, the dry film remains bright, clear and transparent. Particles are not visible in the dry film.

If dry lubricity of the metal surface is wished, a maximum of 8% solid wax lubricant, calculated on dry film weight can also be added. Such solid waxy substances are obviously non conductive and at such reduced level do not introduce sensible changes in the electrical properties of the film. Wax emulsions of many different kinds are widely used in the industry.

The application of this type of surface treatments for zinc coated steel sheet is currently made by coating with a liquid solution or emulsion of chemicals, on a long running metal steel strip surface, in a continuous way, by means of roller systems, more specifically chem, coater or roll, coater machines. Afterwards a suitable drier heats in seconds the sheet, evaporates the water solvent or diluents, leaving a very thin cured solid multipurpose film on the metal surface. Finally the metal strip is coiled.

Most often such coating and drying equipment is installed in the last section of continuous sheet galvanizing lines and applies the treatment once the steel is already coated with a layer of zinc, or aluminium or his alloys.

Obvious economic requirements dictate that modern lines are getting faster. Lines of more than 120 m/min are now common. Modern lines of close to 180 m/min do already work and are now most common in the drawing boards of engineering firms.

But too applications by other techniques are possible as dipping, spraying, flow coating, centrifugation, according to the design of the part to be coated.

Such wide spectra of application techniques demand that concentration, viscosity, surface tension, pH and drying features must be adapted to the application installation in each case. Those secondary changes are commonly known by anybody familiar with this art.

### DETAILED DESCRIPTION OF THE INVENTION

Conductivity measurements on surfaces, coated by essentially non conductive thin films are a real challenge to get objectivity and reproducibility from the tests. Always the test must be repeated several times in different spots off the surface to get an idea of the range of the values. A few very deviating anomalous values are common and must be discarded. This is because the surface conductivity is irregular often altered by defects or singularities in the continuity of the coating.

A small change on the measuring head contact shape or pressure may change the reading. Also the electrical currents used for the measurement are very low and the sensitivity of the Ohmmeter must be extreme. Even if the average thickness of the coating is carefully controlled.

Thickness values for such thin coatings are given in this patent in g/m2. Those values are measured gravimetrically from the surface area coated and the specimen weight difference before and after the treatment. This is much more accurate and realistic than values given in microns. Values in microns in literature regarding surface treatments most often are recalculated from weight measurements assuming a thin dry film specific weight that can only be estimated. Furthermore, because the roughness of the base material is close to the estimated average coating thickness, the real thickness of the coating fluctuates wildly from point to point. Therefore a value in microns has no real physical meaning. But a value in g/m2 does really has a physical meaning.

Examples are only described for Hot Dip Galvanized and Electrolytically Galvanized Steel Sheet. As those metal substrates are today by far the most important metal surfaces where surface conductivity is important.

Corrosion performance is given in hours of Salt Spray treatment till 5% of the exposed surface shows white rust. The Salt Spray treatment is defined by the ASTM B-117 standard.

Conductivity measurements have been done with:

A/ By a precision four wire electronic Lutron Mo-2001 MilliOhmeter. Such system sends very small electrical currents between two of the wires while measures the Voltage difference within the other two wire contacts. Rounded polished surface copper contact electrodes are used. Electrode surface is carefully polished before each set of measurements. High contact pressure between the electrode and the metal surface is avoided. Measured areas are afterwards controlled on corrosion to make sure that the measurement has not lead to surface damages showing in the Salt Spray as premature white rust spots.

The system scans every second the electrodes and measures the conductivity. Lectures in a digital display do anyway fluctuate strongly; so a range of lectures is obtained.

This Ohmmeter has several measuring ranges. The most representative and useful range is from 0 to 2000 MilliOhms.

B/_Newest measuring equipment has been adopted in several electronic manufacturers. The Mitsubishi Electrical Corporation distributes four wire electronic MilliOhmmeters based in measuring heads that contain four gold plated thin needles, with a rounded tip, that give a low and controlled pressure to the contacts with the surface to be measured. Such Loresta GP equipment has a digital microprocessor and is extremely accurate, but due to the different geometry of the measuring heads gives lectures very different to the former. The system has different measuring ranges from the 10−3 power of one Ohm to the 10+7 power. The display automatically chooses the right measuring range. Values exceeding 10+7 are shown in the display as OVER LOAD. Those lectures are now well accepted in the electronic industry.

The system does also follow the four wire principle, two wires sending the current and two wires measuring voltages. It explores the measures every second but after a several or many scans the optical panel display stabilises in the value that fits best the readings done.

### EXAMPLE 1

A slurry of 14 parts of Zinc oxide powder with parts water is made. Then 0.5 part of Aluminium Hydroxide is added and the slurry is mixed carefully.

The slurry is then added to 55.5 parts of 75% Orthophosphoric acid water solution. And the mixture is stirred till finally the liquid becomes completely clear.

### EXAMPLE 2

A slurry of 14 parts of Zinc oxide powder with 30 parts water is made. Then 0.5 part of Vanadium Pentoxide is added and the slurry is mixed carefully.

The slurry is then added to 55.5 parts of 75% Ortho-phosphoric acid water solution. And the mixture is stirred till finally the liquid becomes completely clear.

### EXAMPLE 3

A slurry of 14 parts of Zinc oxide powder with 30 parts water is made. Then 0.5 part of Lithium hydroxyide monohydrate is added and the slurry is mixed carefully.

The slurry is then added to 55.5 parts of 75% Ortho-phosphoric acid water solution. And the mixture is stirred till finally the liquid becomes completely clear.

### EXAMPLE 4

A slurry of 14 parts of Zinc oxide powder with 30 parts water is made. Then the slurry is mixed carefully.

The slurry is then added to 51 parts of 75% Ortho-phosphoric acid mixed with 5 parts of an 50% concentration Trivalent Chromium Chloride water solution. And the mixture is stirred till finally the liquid becomes completely clear.

### EXAMPLE 5

A slurry of 16 parts of Lithium Hydroxide monohydrate powder with 30 parts water Is made. Then the slurry is mixed carefully.

The slurry is then added to 54 parts of 75% Ortho-phosphoric acid water solution. And the mixture is stirred till finally the liquid becomes completely clear.

### EXAMPLE 6

A core-shell additive polymer emulsion was prepared in the following way:

620 ml of water is introduced in an stirred reactor and 160 g of Methyl-metacrylate is dispersed with the help of 10 g of Dodecylbenzene sulphonic acid under an inert atmosphere. The dispersion is the heated at 70° C. and then 4 g of Ammonium persulphate diluted in 10 g of water are added. The batch is held at 70° C. under stirring along 3 hours of stirring. In that way a copolymer emulsion of Polymethyl metacrylate is prepared that will become the core of micelles.

300 ml of such Polymethyl metacrylate emulsion is set again in a stirred reactor and 2.4 g of Ethylene dioxithiophene (EDOT) are added. After 30 minutes of stirring 6.1 g of Ammonium persulphate are again added to the mixture at 30° C. and the batch is left under stirring for 20 hours. In that way a thin shell of a conducting copolymer is built around the core micelles.

The product is left to cool at room temperature, is then purified using dialysis bags an finally filtered with a 100 microns filter mesh.

### EXAMPLES 7a AND 7b

A common chrome and acrylic copolymer containing composition, Brugal GM4-SRF of Procoat Tecnologias SL. is applied by dipping in a diluted bath to ensure 0.6 g/m2 dry film thickness and dried at 75° C. PMT (Peak Metal Temperature measured with a contact Thermocouple on the metal surface).

As the Chromium six is very effective in passivation corrosion performance is good even the dry film is really very thin. And too, because the film is very thin and there are many not visible surface defects, electrical conductivity is adequate.

### EXAMPLES 8a, 8b AND 8c

A Chrome free, but containing a Hexafluotitanium complex passivation, based acrylic copolymer contained composition, Brugal 661/4-SRF of Procoat Tecnologías S.L. is applied also by dipping in a diluted bath to have panels coated at different coating weights. Drying is also done at 75° C. PMT.

This treatment does not contain dissolved phosphates. Thin enough films are good in conductivity but not good on corrosion. Thicker films are good in Corrosion but fail in this conductivity test. This composition is following the EP 0 694 593 patent.

### EXAMPLES 9a, 9b AND 9c

A treatment concentrate is made by mixing.
35 parts of an acrylic copolymer emulsion of 30° C. glass transition temperature and an emulsifier package compatible with low pH's. This emulsion has 42% Dry solids content.
10 parts of an 8% titanium solution as a lactate complex. For example like Tyzor LA of the Du Pont company.
1 part of a 35% hydrogen peroxide solution.
28 parts of a phosphate solution as described in example 1.
21 parts of demineralised water.
5 parts of an ethoxylated alkyl phosphate

This concentrate is then diluted to adjust the amount deposited by dipping and letting drip off vertically the excess product during 30 seconds.

After drip-off the electro-galvanized sheets are dried in an oven to PMT 75° C.

Panels of different weights are obtained.

At 0.6 g/m2 corrosion protection is too low but at 0.8 and 1.2 g/m2 is OK. The Conductivity is in all cases OK.

### EXAMPLES 10, 11, 12 AND 13

The same procedure as in examples 9 is followed but the addition of a phosphate solution of example 1 is changed by examples 2, 3, 4 and 5 solutions.

Film weight is adjusted at 1 g/m2.

Example 10 uses the example 2 phosphate solution.

Example 11 uses the example 3 phosphate solution.

Example 12 uses the example 4 phosphate solution.

Example 13 uses the example 5 phosphate solution.

### EXAMPLE 14

A treatment concentrate is made by mixing.
35 parts of an acrylic copolymer emulsion of 30° C. glass transition temperature and an emulsifier package compatible with low pH's. This emulsion has 42% Dry solids content.
10 parts of an 8% titanium solution as a lactate complex. For example like Tyzor LA of the Du Pont company.
1 part of a 35% hydrogen peroxide solution.
28 parts of a phosphate solution as described in example 1.
21 parts of demineralised water.
5 parts of an ethoxylated alkyl phosphate.

This concentrate is then diluted to adjust the amount deposited by dipping and letting drip off vertically the excess product during 30 seconds.

After drip-off a hot dip galvanized sheet is dried in an oven to 75° C. PMT.

Dry film weight is adjusted at 0.8 g/m2. Both corrosion and conductivity are good.

### EXAMPLE 15

A treatment concentrate is made by mixing.
35 parts of an acrylic copolymer emulsion of 30° C. glass transition temperature and an emulsifier package compatible with low pH's. This emulsion has 42% Dry solids content.
10 parts of an 8% titanium solution as a lactate complex. For example like Tyzor LA of the Du Pont company.
1 part of a 35% hydrogen peroxide solution.
28 parts of a phosphate solution as described in example 4.
21 parts of an, partly hydrolysed and ethanol stabilised, 20% demineralised water solution of a silane.
5 parts of an ethoxylated alkyl phosphate.

This concentrate is then diluted to adjust the amount deposited by dipping and letting drip off vertically the excess product during 30 seconds.

After drip-off the electro-galvanized sheets are dried in an oven to PMT 75° C.

Dry film weight is adjusted at 0.8 g/m2. Both corrosion and conductivity are good.

### EXAMPLE 16

A treatment concentrate is made by mixing.
35 parts of an acrylic copolymer emulsion of 30° C. glass transition temperature and an emulsifier package compatible with low pH's. This emulsion has 42% Dry solids content.
10 parts of an 8% titanium solution as a lactate complex. For example like Tyzor LA of the Du Pont company.
1 part of a 35% hydrogen peroxide solution.
28 parts of a phosphate solution as described in example 4.
21 parts of demineralised water.
5 parts of an ethoxylated alkyl phosphate.
This concentrate is then diluted to adjust the amount deposited by dipping and letting drip off vertically the excess product during 30 seconds.

After drip-off the electro-galvanized sheets are dried in an oven to PMT 75° C.

Dry film weight is adjusted at 0.8 g/m2. Both corrosion and conductivity are good.

### EXAMPLE 17

A treatment concentrate is made by mixing.
35 parts of an acrylic copolymer emulsion of 30° C. glass transition temperature and an emulsifier package compatible with low pH's. This emulsion has 42% Dry solids content.
10 parts of an 8% titanium solution as a lactate complex. For example like Tyzor LA of the Du Pont company.
1 part of a 35% hydrogen peroxide solution.
28 parts of a phosphate solution as described in example 4.
26 parts of demineralised water.

This concentrate is then diluted to adjust the amount deposited by dipping and letting drip off vertically the excess product during 30 seconds.

After drip-off the electro-galvanized sheets are dried in an oven to PMT 75° C.

Dry film weight is adjusted at 0.8 g/m2. Corrosion is good but conductivity drops in a sensible way.

Compared with example 16 this example shows the synergic action of the ethoxylated alkyphosphate additive along the Zinc Phosphate solution component. See too the example 13 where, instead of Zinc Phosphate, Lithium Phosphate is used along the Ethoxylated Alkylphosphate. Conductivity is then also much worse.

### EXAMPLE 18

A treatment concentrate is made by mixing:
30 parts of an acrylic copolymer emulsion of 30° C. glass transition temperature and a emulsifier package compatible with low pH's. This emulsion has 42% solids content.
5 parts of a 50% fluotitanic acid water solution.
1 part of a 35% hydrogen peroxide solution.
20 parts of a phosphate solution as described in example 1.
5 parts of an ethoxlated alkyl phosphate anti-static agent.
20 parts of an core shell copolymer emulsion containing 24% of an acrylic copolymer as core micelles and extra 0.8% of an poly-tiophene as the shell of micelles. This is as described in the example 6-19 parts of water.

This concentrate is then diluted to adjust the amount deposited by dipping and letting drip off vertically the excess product during 30 seconds.

After drip-off the electro-galvanized panels are dried in an oven to a PMT 75° C.

Panels of different weights are obtained.

Applying more than 0.8 g/m2 dry film on the metal surface the corrosion protection is OK. The electrical conductivity is very good at 1.5 g/m2. And is still good till 3 g/m2.

### EXAMPLE 19

A treatment concentrate is made by mixing
40 parts of an acrylic copolymer emulsion of 30° C. glass transition temperature and a emulsifier package compatible with low pH's. This emulsion has 42% solids content.
5 parts of a 50% fluotitanic acid water solution.
1 part of a 35% hydrogen peroxide solution.
28 parts of a phosphate solution as described in example 1.
5 parts of an ethoxylated alkyl phosphate anti-static agent.
21 parts of water.

This concentrate is then diluted to adjust the amount deposited by dipping and letting drip off vertically the excess product during 30 seconds.

After drip-off the electro-galvanized panels are dried in an oven to a PMT 75° C.

Panels of different weights are obtained.

At more than 0.8 g/m2 the corrosion protection is OK. The Conductivity is good till 1.5 g/m2.

### Summary of the Examples:

TABLE 1
Luttron conductivities

| | | | | Salt | Conductivity |
|---|---|---|---|---|---|
| | | | Dry film | Spray | reading mOhm |
| | | | thickness | Hours to | (Luttron |
| | Cr⁶⁺ | Example | g/m² | 5% WR | method) |
| EZ un- | 0 | | 0 | 5 | 0-24 |
| treated | | | | | |
| (control) | | | | | |
| HDG | 0 | | 0 | 8 | 0-24 |
| untreated | | | | | |
| (control) | | | | | |
| EZ | Yes | 7a | 0.6 | 72 | 100-300 |
| HDG | Yes | 7b | 0.6 | 96 | 250-500 |
| EZ | No | 8a | 0.6 | 20** | 150-250 |
| HDG | No | 8b | 0.6 | 24** | 250-500 |
| HDG | No | 8c | 1.1 | 96 | >2000* |
| EZ | No | 9a | 0.6 | 20** | 025-100 |
| EZ | No | 9b | 0.8 | 48 | 050-200 |
| EZ | No | 9c | 1.2 | 72 | 350-600 |
| EZ | No | 10 | 0.8 | 48 | 100-300 |
| EZ | No | 11 | 0.8 | 96 | 050-300 |
| EZ | No | 12 | 0.8 | 48 | 100-300 |
| EZ | No | 13 | 0.8 | 24** | 500-800* |
| HDG | No | 14 | 0.8 | 96 | 150-300 |
| HDG | No | 15 | 0.8 | 72 | 150-300 |
| HDG | No | 16 | 0.8 | 144 | 150-300 |
| HDG | No | 17 | 0.8 | 96 | 300-400 |
| EZ | No | 18 | 1.5 | 144 | 80-120 |
| EZ | No | 18 | 3.0 | >144 | 200-350 |
| EZ | No | 19 | 1.5 | 144 | 150-400 |

*With this method the electrical Conductivity readings over 600 MilliOhms are considered insufficient.
**Salt Spray Measurements not reaching 48 hours are considered insufficient.

TABLE 2
Loresta conductivities

| | | | Dry film | Salt Spray | Conductivity |
|---|---|---|---|---|---|
| | | | thickness | Hours to | reading mOhm |
| | Cr⁶⁺ | Example | g/m² | 5% WR | (Loresta method) |
| EZ | 0 | | 0 | 5 | 0.080 |
| untreated | | | | | |
| (control) | | | | | |
| HDG | 0 | | 0 | 8 | 0.100 |
| untreated | | | | | |
| (control) | | | | | |
| EZ | Yes | 7a | 0.6 | 72 | 30* |
| HDG | Yes | 7b | 0.6 | 96 | 40* |
| EZ | No | 8a | 0.6 | 20** | >30* |
| HDG | No | 8b | 0.6 | 24** | >80* |
| HDG | No | 8c | 1.1 | 96 | >200* |
| EZ | No | 9a | 0.6 | 20** | 0.080 |
| EZ | No | 9b | 0.8 | 48 | 0.087 |
| EZ | No | 9c | 1.2 | 72 | 0.087 |
| EZ | No | 10 | 0.8 | 48 | 0.090 |
| EZ | No | 11 | 0.8 | 48 | 0.095 |
| EZ | No | 12 | 0.8 | 96 | 0.087 |
| HDG | No | 13 | 0.8 | 24** | 0.110* |
| HDG | No | 14 | 0.8 | 96 | 0.090 |
| HDG | No | 15 | 0.8 | 144 | 0.097 |
| HDG | No | 16 | 0.8 | 144 | >100* |
| HDG | No | 17 | 0.8 | 96 | 5000 |
| EZ | No | 18 | 1.5 | 144 | 0.085 |
| EZ | No | 18 | 3.0 | >144 | 0.090 |
| EZ | No | 19 | 1.5 | 144 | 0.090 |

*With this method the electrical Conductivity readings over 100 MilliOhms are considered insufficient.
**Salt Spray Measurements not reaching 48 hours are considered insufficient.

1. Corrosion protective and electrical conductivity composition free of inorganic solid particles composition, comprises at least:
A liquid, water based, solution or emulsion, of an organic polymer,
An acidic water based inorganic solution containing at least 3% of the solids contained in the composition as dissolved Zinc as a cation,
Such water solution containing at least 10% of the solids contained in such polymer liquid solution or emulsion as dissolved phosphoric acid or acidic phosphor based salts,
Other anions like glycolates, lactates, oxalates, tartrates, acetyl-acetonates, and hexafluoro complex acids of boron, silicium, titanium, zirconium,
Other metals as cations like aluminium, calcium, lithium, trivalent chrome, manganese, molybdenum, potassium, sodium, titanium, vanadium, are added as oxides, hydroxides or salts, those cations are adjusted with the anion contained in the composition so that all the zinc and those cations present are fully dissolved in the composition,
Some inorganic or organic peroxides in solution.

2. A composition according to claim 1, wherein is added some organic surface active agent than gives antistatic electrical charge protection in more than 2% concentration calculated on the treatment solid content, like etoxilated alkyl sulphate or alkyl phosphate neutralized with ammonia, lithium, sodium or potassium, or a polyoxyethylene copolymer including also a mixture or such kind of compound with the former ones.

3. A composition according to claim 1, wherein is added a liquid containing silane or a silane mix as adhesion promoters, cross-linkers or hydrophobic agents.

4. A composition according to claim 1, wherein is added a maximum of 8% of a solid organic wax, calculated on dry film weight.

5. A composition according to claim 1, wherein is added by polymerising around the core of the emulsified micelles a thin shell of a conducting polymer.

6. A composition according to claim 5, wherein the conductive organic polymer is poly-pyrrol, poly-aniline or poly-thiophene.

7. Process for the metallic surface treatment which comprises applying an appropriate amount of the composition according to any one of claims 1 to 5 to a clean metallic surface as a wet film, and drying or curing at a temperature ranging between 40° C. and 240° C. leaving then on the metal surface an optically transparent dry film from 0.4 to 5 g/m2.

8. Process according to claim 7 wherein the temperature is measured in the surface of the metal with a contact thermocouple, diluting the compositions with extra water to adjust the final dry film thickness.

9. Process according to claim 7 wherein the optically transparent dry film is from 0.7 to 1.3 g/m2.

10. Process according to claim 7 wherein the drying or curing is made by hot air streams, or inductive heating of the metal sheet, or with radiations like IR, UV or Electron-beams.
